(19) United States
(12) Patent Application Publication
(10) Pub. No.: US 2026/0300346 A1
(43) Pub. Date: Oct. 1, 2026

(54) INFORMATION PROCESSING APPARATUS, INFORMATION PROCESSING METHOD, AND A NON-TRANSITORY COMPUTER-READABLE STORAGE MEDIUM

(71) Applicant: CANON KABUSHIKI KAISHA, Tokyo (JP)

(72) Inventor: Ichiko MAYUZUMI, Kanagawa (JP)

(21) Appl. No.: 19/629,006

(22) Filed: Mar. 26, 2026

(30) Foreign Application Priority Data
Apr. 1, 2025 (JP) 2025-060706

(51) Int. Cl. G06F 16/334; G06F 16/3329

(52) U.S. Cl. CPC G06F 16/334; G06F 16/33295

(57) ABSTRACT

An information processing apparatus comprises an identification unit configured to identify a location in a document including information related to an answer to a question from a user as a source location based on the question, an acquisition unit configured to acquire a generation result generated by a large language model that has received a prompt instruction for acquiring difference information indicating differences in a plurality of source locations identified by the identification unit, or respective categories of the plurality of source locations identified by the identification unit, and an output unit configured to output the difference information or the categories based on the generation result.

### BACKGROUND

### Field of the Technology

The present disclosure relates to a technology for responding to a question.

### Description of the Related Art

As the database formation of documents within a company progresses, the importance of a document search system for efficiently searching for documents necessary for business is increasing. In a search system, a technology has been proposed that makes it easy to select a desired search result from a group of search results by presenting characteristics for each source of the search results.

In Japanese Patent No. 7545061, a technology is disclosed that displays an identification word of a document, determined based on a preset priority rule from a group of words characterizing the document acquired for each document to be searched, in association with the document so as to be identifiable.

In the method of Japanese Patent No. 7545061, it was difficult to select a desired search result from a group of search results when the word groups characterizing the documents to be searched are similar between the documents.

### SUMMARY

According to the aspect of the present disclosure, there is provided an information processing apparatus comprising: an identification unit configured to identify a location in a document including information related to an answer to a question from a user as a source location based on the question; an acquisition unit configured to acquire a generation result generated by a large language model that has received a prompt instruction for acquiring difference information indicating differences in a plurality of source locations identified by the identification unit, or respective categories of the plurality of source locations identified by the identification unit; and an output unit configured to output the difference information or the categories based on the generation result.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a diagram illustrating a usage scene of a system.

FIG. 2A is a block diagram illustrating a hardware configuration example of a tablet 103.

FIG. 2B is a block diagram illustrating a hardware configuration example of a search system 104.

FIG. 3 is a block diagram illustrating a functional configuration example in each of the tablet 103 and the search system 104.

FIG. 4 is a flowchart of processing performed by each of the tablet 103 and the search system 104.

FIG. 5 is a diagram illustrating an example of a prompt template.

FIG. 6 is a diagram illustrating a presentation example by a presentation device 204.

FIG. 7 is a diagram illustrating an example of a prompt template.

FIG. 8 is a diagram illustrating a presentation example by the presentation device 204.

FIG. 9 is a diagram illustrating a configuration example of a presentation screen.

FIG. 10A is a diagram illustrating an example of a prompt template.

FIG. 10B is a diagram illustrating a presentation example by the presentation device 204.

FIG. 11A is a diagram illustrating an example of a prompt template.

FIG. 11B is a diagram illustrating an example of a presentation by the presentation device 204.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

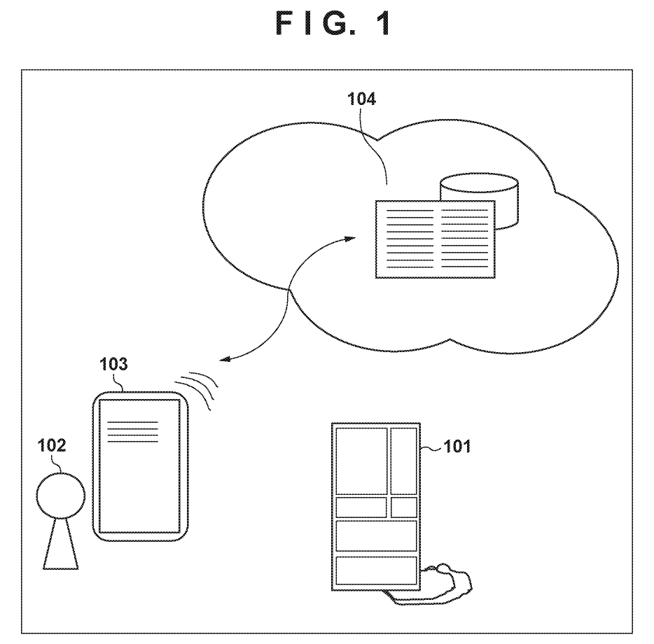

First, a usage scene of a system according to the present embodiment will be described with use of FIG. 1. In the usage scene of FIG. 1, a problem has occurred in a refrigerator 101. The problem occurring in the refrigerator 101 is, for example, a water leakage failure. A service person 102 (user) called for repair of the refrigerator 101 uses a tablet 103, which is an example of an information processing apparatus, to investigate a solution method in order to solve the problem. First, the service person 102 operates the tablet 103 to input a question, and when the input of the question is finished, instructs transmission of the question. When the transmission of the question is instructed, the tablet 103 transmits the input question to a search system 104, which is an example of an information processing apparatus, via a wireless network. Based on the question received from the tablet 103, the search system 104 identifies locations in documents including information related to an answer to the question as source locations, acquires difference information indicating differences in the plurality of the identified source locations, and transmits the acquired difference information to the tablet 103. The tablet 103 receives the difference information received from the search system 104 and presents it to the service person 102. The service person 102 identifies a solution method for the problem of the refrigerator 101 based on the presented difference information.

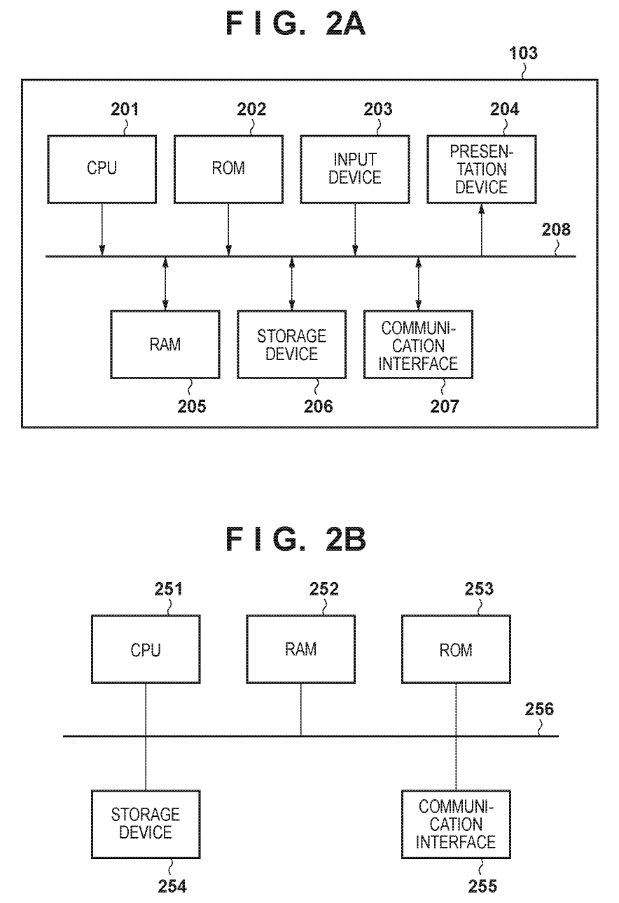

Next, a hardware configuration example of the tablet 103 will be described with use of the block diagram of FIG. 2A. Note that the hardware configuration example shown in FIG. 2A is an example of a hardware configuration applicable to the tablet 103, and modification/change is possible as appropriate.

A CPU 201 executes various types of processing with use of computer programs and data stored in a RAM 205. Accordingly, the CPU 201 performs operation control of the entire tablet 103 and executes or controls various types of processing described as processing performed by the tablet 103.

Setting data of the tablet 103, computer programs and data related to startup of the tablet 103, computer programs and data related to a basic operation of the tablet 103, and the like are stored in a ROM 202. For example, a BIOS (Basic Input/Output System) program, a boot program, and the like are stored in the ROM 202.

An input device 203 is a user interface such as a keyboard, a mouse, or a touch panel, and can input various instructions and information to the tablet 103 by a user operating it.

A presentation device 204 is an interface for presenting a processing result by the tablet 103 to the user. For example, the presentation device 204 has a liquid crystal screen or a touch panel screen, and can display a processing result by the CPU 201 as an image or text. Further, for example, the presentation device 204 has a speaker and can output a processing result by the CPU 201 as sound.

The RAM 205 has an area for storing computer programs and data loaded from the ROM 202 or a storage device 206, and an area for storing computer programs and data received from an external apparatus via a communication interface 207. Furthermore, the RAM 205 has a work area used when the CPU 201 executes various types of processing. In this way, the RAM 205 can provide various areas as appropriate.

The storage device 206 is a non-volatile memory device such as an SSD (Solid State Drive) or an HDD (Hard Disk Drive). An OS, computer programs and data for causing the CPU 201 to execute or control various types of processing described as processing performed by the tablet 103, and the like are saved in the storage device 206.

The communication interface 207 is an interface for the tablet 103 to perform data communication with an external apparatus via a network such as a LAN or the Internet. The network may be a wired network or may be a wireless network. Further, the type of network is not limited to a specific type such as USB or serial communication.

The CPU 201, the ROM 202, the input device 203, the presentation device 204, the RAM 205, the storage device 206, and the communication interface 207 are all connected to a system bus 208.

Next, a hardware configuration example of the search system 104 will be described with use of the block diagram of FIG. 2B. Here, a case where the search system 104 is implemented by one computer apparatus will be described, but this is not a limitation, and the search system 104 may be implemented by a plurality of computer apparatuses.

A CPU 251 executes various types of processing with use of computer programs and data stored in a RAM 252. Accordingly, the CPU 251 performs operation control of the entire search system 104 and executes or controls various types of processing described as processing performed by the search system 104.

The RAM 252 has an area for storing computer programs and data loaded from a ROM 253 or a storage device 254, and an area for storing computer programs and data received from an external apparatus via a communication interface 255. Furthermore, the RAM 252 has a work area used when the CPU 251 executes various types of processing. In this way, the RAM 252 can provide various areas as appropriate.

Setting data of the search system 104, computer programs and data related to startup of the search system 104, computer programs and data related to a basic operation of the search system 104, and the like are stored in the ROM 253.

The storage device 254 is a non-volatile memory device such as an SSD or an HDD. An OS, computer programs and data for causing the CPU 251 to execute or control various types of processing described as processing performed by the search system 104, and the like are saved in the storage device 254.

The communication interface 255 is an interface for the search system 104 to perform data communication with an external apparatus via a network such as a LAN or the Internet. The network may be a wired network or may be a wireless network. Further, the type of network is not limited to a specific type such as USB or serial communication. The CPU 251, the RAM 252, the ROM 253, the storage device 254, and the communication interface 255 are all connected to a system bus 256.

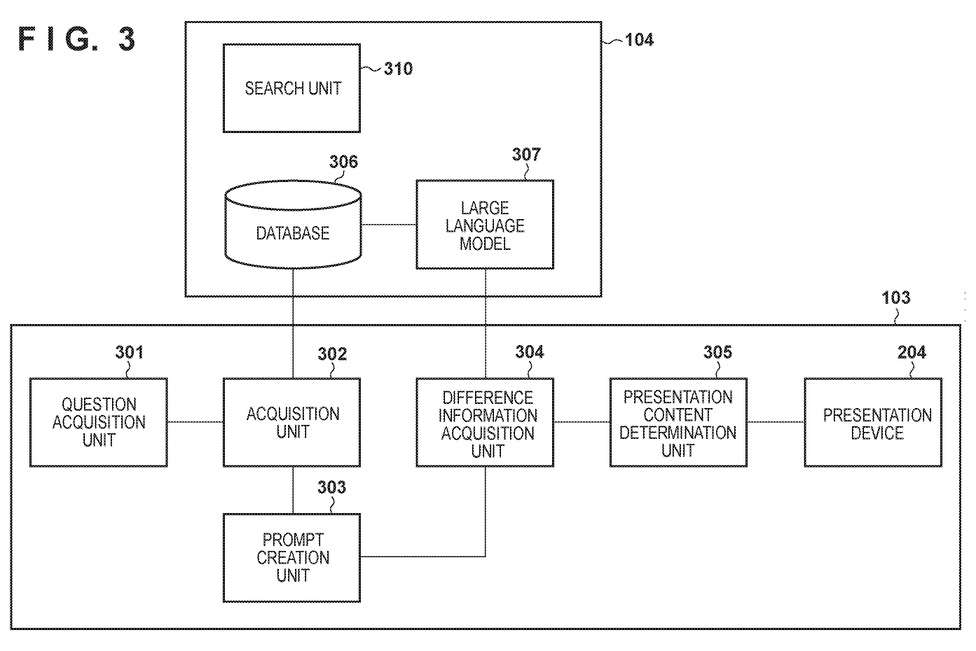

A functional configuration example in each of the tablet 103 and the search system 104 is shown in the block diagram of FIG. 3. In the present embodiment, a case will be described where each functional unit of the tablet 103 shown in FIG. 3 (excluding the presentation device 204) is implemented by software (computer program). Below, there are cases where each functional unit of the tablet 103 in FIG. 3 (excluding the presentation device 204) is described as a subject of processing, but in reality, the function of the functional unit is realized by the CPU 201 executing a computer program corresponding to the functional unit.

Further, in the present embodiment, a case will be described where a search unit 310 of the search system 104 shown in FIG. 3 is implemented by software (computer program). Below, there are cases where the search unit 310 is described as a subject of processing, but in reality, the function of the search unit 310 is realized by the CPU 251 executing a computer program corresponding to the search unit 310.

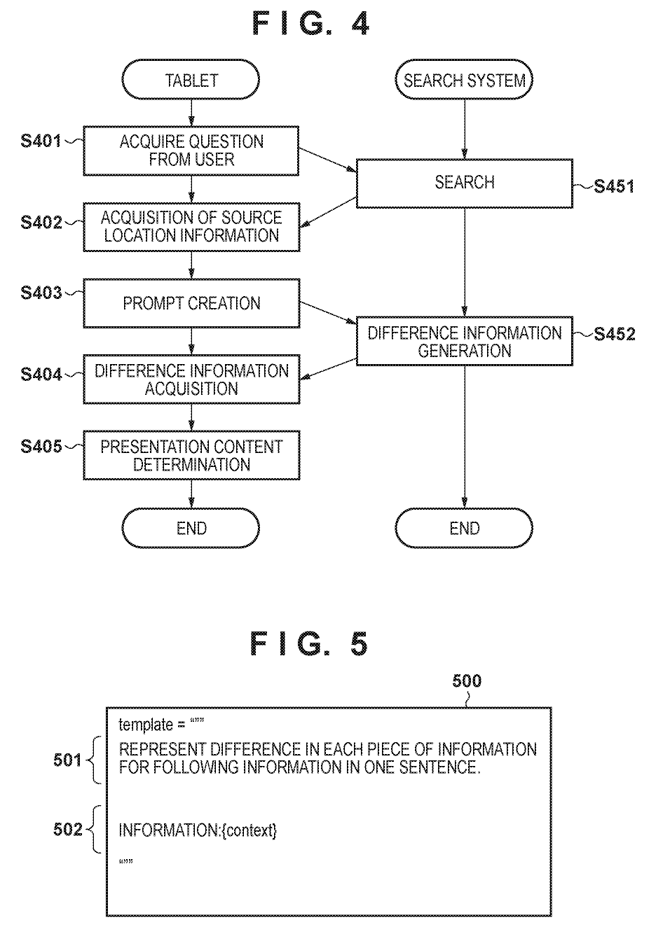

Processing performed by each of the tablet 103 and the search system 104 in order to present to a user difference information indicating differences in described contents in a plurality of source locations regarding an answer to a question input by the user will be described according to the flowchart of FIG. 4. Below, a case where the question is character information will be described as an example.

In step S401, a question acquisition unit 301 acquires a question input according to a user operation. A method of acquiring a question by the question acquisition unit 301 is not limited to a specific method. For example, the question acquisition unit 301 may acquire character information input by the user operating the keyboard or mouse in the input device 203 as a question. Further, for example, the question acquisition unit 301 may recognize a voice input (uttered) by the user to a microphone in the input device 203, and acquire character information that is a result of the recognition as a question. Further, the question acquisition unit 301 may acquire a still image or a moving image input by the user operating the keyboard or mouse in the input device 203 as a question. Then, an acquisition unit 302 transmits the question acquired by the question acquisition unit 301 to the search system 104 via the communication interface 207.

In step S451, the search unit 310 receives the question transmitted from the tablet 103 via the communication interface 255. The search system 104 has a database 306, which is a document-oriented database that vectorizes and saves character data such as text (documents in a field to be searched in order to obtain an answer to a user's query accumulated internally and externally, such as, for example, information related to maintenance of the refrigerator 101, information related to product design of the refrigerator 101, knowledge information, etc.). The database 306 is saved in, for example, the storage device 254. Documents saved in the database 306 need to be in a general document file format such as a text format or a document format that can be vector-converted. Documents saved in the database 306 are not limited to a general document file format, and may include element data that is non-character information or a mixture of character information and non-character information, such as images, audio, video, drawings, and tables.

Therefore, the search unit 310 converts, for example, the question received from the tablet 103 into vector data (question vector data), and calculates a cosine similarity between the question vector data and vector data of text in each paragraph in one or more documents registered in the database 306. Then, the search unit 310 identifies, among the respective paragraphs, a paragraph for which a cosine similarity equal to or greater than a threshold is calculated as a location in a document including information related to an answer to the question (source location), and generates, for each of the identified paragraphs, a set of an ID of the paragraph (paragraph ID) and an ID of the document to which the paragraph belongs (document ID) as source location information. Then, the search unit 310 transmits the generated source location information to the tablet 103 via the communication interface 255.

In step S402, the acquisition unit 302 receives (acquires) the source location information transmitted from the search system 104 via the communication interface 207. In step S403, the prompt creation unit 303 creates a prompt for inquiring about differences regarding described contents between the respective source locations identified by the source location information received in step S402.

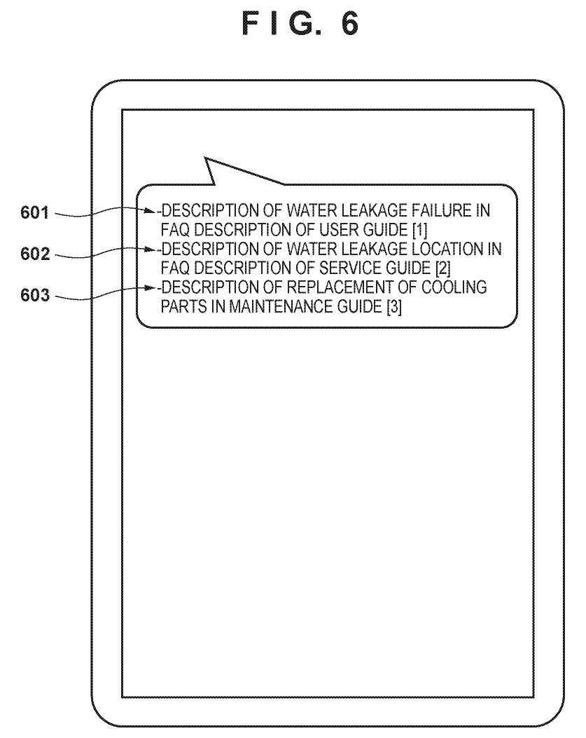

For example, the prompt creation unit 303 creates a prompt by inserting the source location information acquired in step S402 into a prompt template that is a predetermined character string. The prompt template is stored in advance in the ROM 202 or the storage device 206. An example of the prompt template is shown in FIG. 5. The prompt is expressed in a Markdown format.

In a prompt template 500, a description 501 is a fixed sentence (inquiry sentence) for inquiring about differences in described contents between source locations. A description 502 is a sentence for specifying a group of source locations. The prompt creation unit 303 inserts the source location information received in step S402 as a list of character strings into a "context" part in the description 502. Then, the prompt creation unit 303 transmits the created prompt to the search system 104 via the communication interface 207.

In step S452, the search unit 310 receives the prompt transmitted from the tablet 103 via the communication interface 255. Then, the search unit 310 replaces the source location information in the received prompt with a source location corresponding to the source location information (text of a paragraph in a document identified by a paragraph ID and a document ID indicated by the source location information), and by inputting the prompt after the replacement into a large language model 307 and processing the large language model 307, generates difference information indicating differences regarding described contents between the respective source locations.

The large language model 307 is a general-purpose large language model, and generates an answer sentence with a question sentence called a prompt as an input. Information output by the large language model 307 is character information, and since the description 501 in the prompt instructs that differences in the source locations be expressed in one sentence, a list of text in which the differences are expressed in one sentence for each source location is output as the difference information. As the large language model 307, GPT-4 (registered trademark), which is a general-purpose model, is used, and it is a model in which grammar, meanings of words, and the like are pre-trained in an unsupervised manner using a large amount of text data. Then, the search unit 310 transmits the generated difference information to the tablet 103 via the communication interface 255.

In step S404, a difference information acquisition unit 304 receives the difference information transmitted from the search system 104 via the communication interface 207. In step S405, a presentation content determination unit 305 determines the respective differences indicated by the difference information received in step S404 as contents to be presented to the user (presentation contents), and causes the presentation contents to be presented to the user via the presentation device 204.

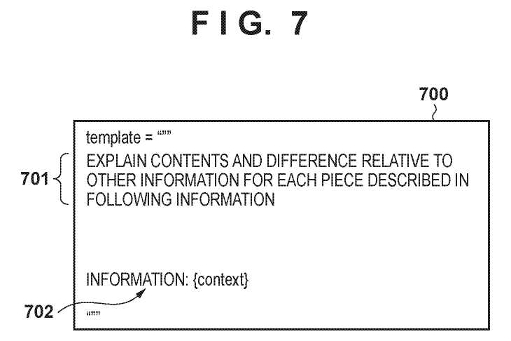

For example, the presentation content determination unit 305 may cause a screen including, as shown in FIG. 6, one sentence 601 representing a difference relative to other source locations in one source location (first source location), one sentence 602 representing a difference relative to other source locations in another source location (second source location) different from the first source location, and one sentence 603 representing a difference relative to other source locations in another source location (third source location) different from the first source location and the second source location, to be displayed on a display screen of the presentation device 204. Note that the method of presenting the presentation contents is not limited to display, and for example, the presentation contents may be presented to the user by voice.

In this way, according to the present embodiment, even in a case where word groups characterizing documents to be searched are similar between the documents, it is possible to make it easy for a user to select a desired search result from a group of search results.

### Modification 1 of First Embodiment

As described above, in a case where a user inputs a question by voice to a microphone in the input device 203, the question acquisition unit 301 converts the input voice into character information, and in that case, performs conversion with use of a general-purpose voice recognition model (for example, Whisper (registered trademark)). Such conversion processing is performed in the above-mentioned step S401.

In this way, according to the present modification, even in a case where it is difficult for a user to perform character input, it is possible to input a question to the tablet 103, and the processing from step S402 onward can be executed.

### Modification 2 of First Embodiment

In the first embodiment, the search system 104 allowed a plurality of documents as text to be searched for a question from a user. In contrast, in the present modification, a case will be described where a document to be searched for a question from a user is one document.

In the database 306, vector data of text of each paragraph is registered for each paragraph in one document (target document). Therefore, the search unit 310 calculates, for example, a cosine similarity between question vector data and vector data of text of each paragraph in the target document. Then, the search unit 310 identifies, among the respective paragraphs, a paragraph for which a cosine similarity equal to or greater than a threshold is calculated as a source location, and generates, for each of the identified paragraphs, a set of an ID of the paragraph (paragraph ID) and an ID of the target document (document ID) as source location information.

In this way, according to the present modification, a plurality of source locations are presented from one document, and because they have similar contents, even in a case where it is difficult for a user to select a result, a desired search result can be selected.

### Modification 3 of First Embodiment

In the first embodiment, the unit of the source location was a paragraph. However, the source location may be information indicating an area in a document of a series of character strings in the document, and the unit is not limited to a paragraph. For example, in a case where the unit of the source location is a section, the source location information is a set of an ID of the section (section ID) and a document ID. In addition to the section unit, a chapter unit, a page unit, and a character unit are candidates. Furthermore, the unit of the source location is not limited to a unit in a document, and a case where a document is the unit is also conceivable. In a case where contents of one document are contents to be acquired as a source location, the document itself is the source location unit.

Further, in the first embodiment, the unit of the source location was of one type, but it is not limited to this, and a plurality of types of units may be used in combination. In this case, an identifier indicating a type of the source location unit is added to each piece of source location information.

In this way, according to the present modification, because the unit of the source location is selectable, such as a document unit or a paragraph unit, an appropriate source location can be acquired. Further, the unit of the source location may be made selectable by including a unit that the user wants to be presented in the question. Accordingly, it is possible to acquire a source location according to a user's intention and present difference information.

### Modification 4 of First Embodiment

In the first embodiment, a source location was searched for by a search based on vector data (vector search), but a search method for a source location is not limited to the vector search as long as it is a search of a document database. For example, a source location may be searched for with use of a search method such as full-text search, keyword search, or faceted search.

Furthermore, a plurality of search methods may be used in combination for acquisition of a source location. For example, in a case where a hybrid search of vector search and full-text search is used, the accuracy of keyword search and the semantic relationship of vector search can be made compatible, and a highly accurate search result can be obtained. In the present modification, a case will be described where a hybrid search of vector search and full-text search is used. Processing performed by each of the tablet 103 and the search system 104 in order to present difference information to a user is processing according to the flowchart of FIG. 4, except for the following points.

In step S451, the search unit 310, similarly to the first embodiment, converts a question received from the tablet 103 into question vector data, calculates a cosine similarity (vector search score) between the question vector data and vector data of text in each paragraph in one or more documents registered in the database 306, and performs vector search for identifying a paragraph for which a cosine similarity equal to or greater than a threshold is calculated among the respective paragraphs as a source location.

Further, the search unit 310 indexes each document saved in the database 306, and performs full-text search for searching for a paragraph that matches the question received from the tablet 103 in the document. In the full-text search, a score (full-text search score) is calculated for each searched paragraph. For the full-text search, Elasticsearch, which is a distributed search engine that efficiently executes full-text search, is used, and a paragraph including a specific keyword is acquired as a source location as a result of the full-text search.

Then, the search unit 310 calculates an integrated score for each searched paragraph by normalizing and weight-adding each of the vector search score and the full-text search score calculated for the paragraph.

Weighting for each of the vector search score and the full-text search score is adjusted according to how much importance is placed on semantic relevance or how much importance is placed on a degree of keyword matching. Here, as an example in which importance is placed on semantic relevance, a weight for vector search is set high. For example, in a case where a weight for the vector search score is set to 0.6 and a weight for the full-text search score is set to 0.4, the integrated score is calculated as integrated score = 0.6 × vector search score + 0.4 × full-text search score.

Then, the search unit 310 identifies, among the respective paragraphs, a paragraph for which an integrated score equal to or greater than a threshold is calculated as a location in a document including information related to an answer to the question (source location), and generates, for each of the identified paragraphs, a set of an ID of the paragraph (paragraph ID) and an ID of the document to which the paragraph belongs (document ID) as source location information. Accordingly, a search result considering semantic relevance and a degree of keyword matching is obtained.

In this way, according to the present modification, a search result considering semantic relevance and a degree of keyword matching at the same time can be acquired by a hybrid search using vector search and full-text search. Accordingly, a user can acquire information with higher relevance as a source location.

### Modification 5 of First Embodiment

In the first embodiment, the prompt creation unit 303 used a prompt template, which is a predetermined (fixed) character string, in order to create a prompt, but a prompt may be any prompt as long as it inquires about differences in source locations, and the prompt template is not limited to a predetermined (fixed) character string.

For example, the prompt creation unit 303 causes a plurality of sentences created in advance and saved in advance in the storage device 206 to be displayed on a display screen in the presentation device 204. Then, the prompt creation unit 303 sets a sentence selected by a user operating the input device 203 among the plurality of sentences as an inquiry sentence, and creates a prompt including the inquiry sentence and source location information. Alternatively, it is also possible for a prompt to be rewritten from outside the tablet 103, for the tablet 103 to appropriately change an inquiry sentence, or for an inquiry sentence to be generated.

Further, in the first embodiment, the description 501 has contents that instruct to generate differences in described contents for all source locations, but it is not limited to this, and in a prompt, the number of outputs of source locations may be specified. For example, in a prompt, it may be specified to generate differences for 10 paragraphs.

Further, in the first embodiment, the description 501 has contents that instruct to generate differences in described contents of source locations in one sentence, but it is not limited to this, and in a prompt, a length of difference information may be specified by a plurality of sentences or the number of characters.

Further, in the first embodiment, differences in described contents are presented for each source location, but it is not limited to this, and for example, an overview of source locations and difference information may be presented. In this case, the search unit 310 transmits an overview of each source location (a part of the source location) to the tablet 103 in addition to the difference information. Note that the entire source location instead of the overview of the source location may be transmitted.

Further, the length of difference information, the types of information presented regarding source locations, and the mode of presentation may be fixed or may be variable; for example, these may be made changeable based on the amount of information that can be displayed on a display screen in the presentation device 204. In this way, according to the present modification, it is possible to adjust the balance between the scannability of information and the volume of information.

### Modification 6 of First Embodiment

In the first embodiment, a general-purpose model is used as the large language model 307, but the large language model 307 is not limited to a general-purpose model; for example, a dedicated model may be used as the large language model 307. As the dedicated model, a model specialized for a specific field, a selection of a plurality of models having specific characteristics, or a fine-tuned model obtained by re-learning a general-purpose model may be used.

For example, in a case where a model obtained by re-learning a general-purpose model is used as the large language model 307, a general-purpose natural language processing model in which grammar, meanings of words, and the like are pre-trained in an unsupervised manner using a large amount of text data is used as a base model, and knowledge of a specific domain is further subjected to supervised learning. As the base model, learning is performed based on GPT-4 (registered trademark). Further, for a learning dataset used for re-learning, a set group of source location information treated as a correct answer and difference information is prepared and fine-tuning is performed. In this way, according to the present modification, by obtaining more accurate difference information, a user can easily select a desired source location from a plurality of source locations.

### Modification 7 of First Embodiment

In the first embodiment, the presentation content determination unit 305 presents all differences indicated by the difference information received in step S404 to the user, but a part of the differences indicated by the difference information received in step S404 may be presented to the user. In the present modification, a configuration in which a difference to be presented to the user can be selected from a plurality of differences indicated by the difference information received in step S404 will be described. Processing performed by each of the tablet 103 and the search system 104 in order to present difference information to the user is processing according to the flowchart of FIG. 4, except for the following points.

In step S451, the search unit 310 obtains a search score by normalizing, to 0 to 1, the cosine similarity calculated for each source location identified in the same manner as in the first embodiment. Then, the search unit 310 transmits the search score for each source location and the source location information generated in the same manner as in the first embodiment to the tablet 103 via the communication interface 255.

In step S402, the acquisition unit 302 receives (acquires) the search scores and the source location information transmitted from the search system 104 via the communication interface 207.

In step S405, the presentation content determination unit 305 determines contents to be presented to the user (presentation contents) among the differences indicated by the difference information received in step S404 based on the above-mentioned search scores.

For example, the presentation content determination unit 305 determines, among the differences of the respective source locations indicated by the difference information received in step S404, a difference of a source location whose search score is equal to or greater than a threshold as the presentation content.

In this case, the presentation content determination unit 305 may cause the differences of the source locations whose search scores are equal to or greater than the threshold to be displayed on the display screen in the presentation device 204 from the top in descending order of search score. In this way, according to the present modification, by controlling the number of differences presented to the user, it is possible to reduce the time for the user to select a desired source location from the presented information.

### Second Embodiment

In the following respective embodiments and respective modifications including the present embodiment, differences from the first embodiment will be described, and they shall be similar to the first embodiment unless otherwise specifically mentioned below. In the first embodiment, the difference information of source locations was presented to the user in response to a question from the user. In contrast, in the present embodiment, a case will be described where the source location is also presented to the user in addition to the difference information of the source location. Processing performed by each of the tablet 103 and the search system 104 in order to present the difference information and the source location to the user is processing according to the flowchart of FIG. 4, except for the following points.

In step S403, the prompt creation unit 303 creates a prompt for inquiring about respective source locations identified by the source location information received in step S402 and differences regarding described contents between the respective source locations.

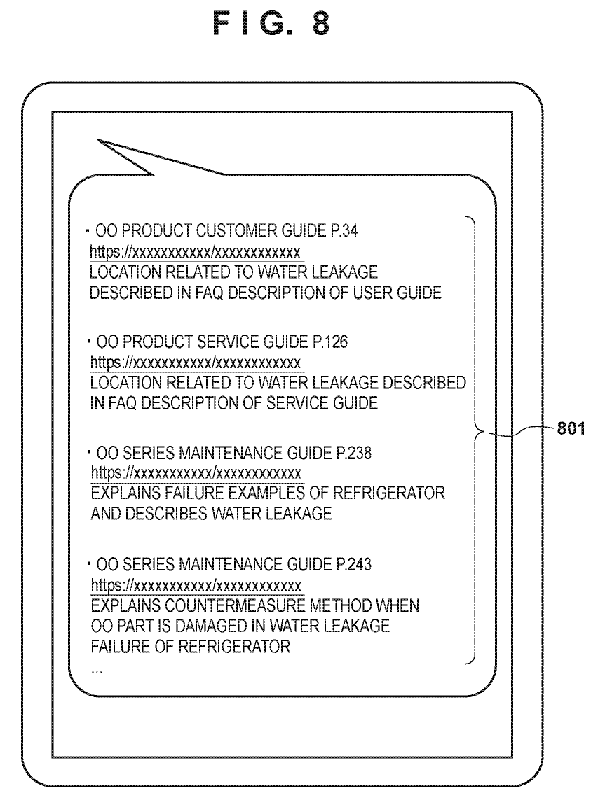

For example, the prompt creation unit 303 creates a prompt by inserting the source location information acquired in step S402 into a prompt template that is a predetermined character string. The prompt template is stored in advance in the ROM 202 or the storage device 206. An example of the prompt template is shown in FIG. 7.

In a prompt template 700, a description 701 is a fixed sentence for inquiring about source locations and differences in described contents between the source locations. Note that the description 701 is not limited to a fixed sentence, and may be editable by the user operating the input device 203 or may be editable from an external apparatus.

A description 702 is, similar to the description 502, a sentence for specifying a group of source locations. The prompt creation unit 303 inserts the source location information received in step S402 as a list of character strings into a "context" part in the description 702. Then, the prompt creation unit 303 transmits the created prompt to the search system 104 via the communication interface 207.

In step S452, the search unit 310 transmits the source locations to the tablet 103 via the communication interface 255 in addition to the generated difference information. In step S404, the difference information acquisition unit 304 receives the difference information and the source location transmitted from the search system 104 via the communication interface 207.

In step S405, the presentation content determination unit 305 determines the difference regarding each source location indicated by the difference information received in step S404 and the source location as contents to be presented to the user (presentation contents), and causes the presentation contents to be presented to the user via the presentation device 204.

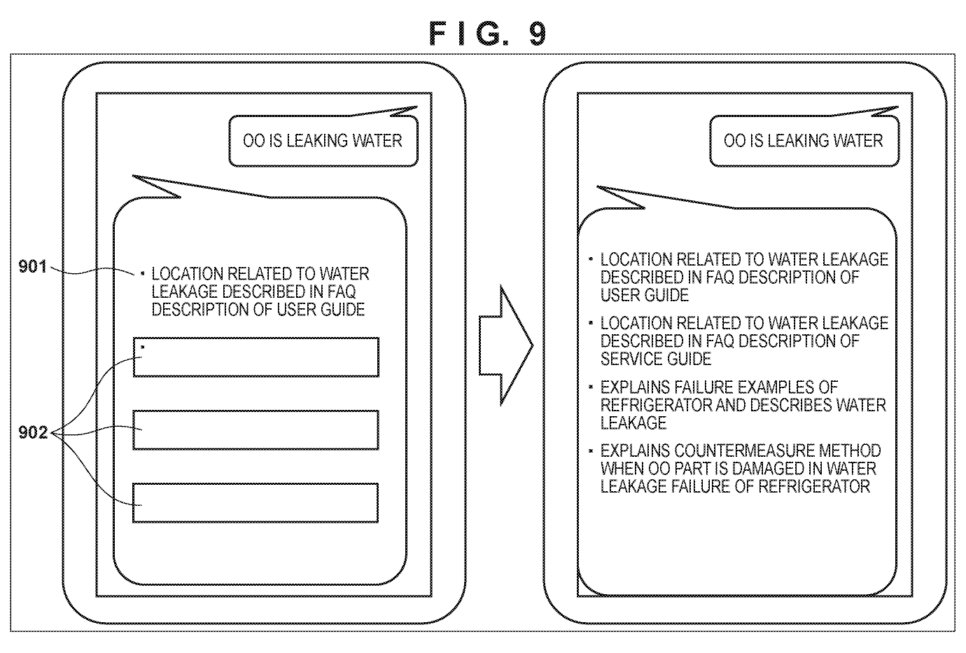

For example, the presentation content determination unit 305 may cause a screen of a list 801 including, for each source location, a set of the source location and one sentence representing a difference relative to other source locations in the source location, to be displayed on the display screen of the presentation device 204, as shown in FIG. 8. Note that the method of presenting the presentation contents is not limited to display, and for example, the presentation contents may be presented to the user by voice. In this way, according to the present embodiment, it is possible to make it easier to select a desired search result from a group of search results.

### Third Embodiment

In the first embodiment and the second embodiment, the search system 104 transmits the difference information to the tablet 103 after acquiring all of the difference information of the source locations. In contrast, in the present embodiment, the search system 104 transmits the difference information to the tablet 103 every time difference information is acquired for a prescribed number of source locations. Processing performed by each of the tablet 103 and the search system 104 in order to present the difference information to the user is processing according to the flowchart of FIG. 4, except for the following points.

In step S403, the prompt creation unit 303 creates a prompt for inquiring about differences regarding described contents between respective source locations identified by the source location information received in step S402, and for requesting output for each prescribed number of source locations' difference information. The prescribed number of source locations indicates source locations in a prescribed division, such as one paragraph or two paragraphs. This "prescribed number" may be a value set in advance, or may be set/changed by the user operating the input device 203. Below, a case where the prescribed number is 1 will be described as an example.

In step S452, the search unit 310 receives the prompt transmitted from the tablet 103 via the communication interface 255. Then, the search unit 310 generates difference information in the same manner as in the first embodiment, and every time difference information is generated for a prescribed number of source locations, transmits the difference information generated for the prescribed number of source locations to the tablet 103 via the communication interface 255.

Accordingly, the presentation device 204 can present the difference information to the user every time the difference information is generated for the prescribed number of source locations, without waiting for the generation of difference information for all source locations.

In this way, according to the present embodiment, the initial presentation of difference information to the user becomes faster and difference information can be obtained sequentially; therefore, when information desired by the user is presented, the information can be obtained without waiting for the presentation of difference information until the end.

### Modification of Third Embodiment

In the method of the third embodiment, in a case where difference information is additionally acquired, a presentation position of the difference information presented to the user may change. On the other hand, by inserting a prescribed space between presentation positions of two different pieces of difference information, it is possible to reduce a change in the presentation position of information when difference information is additionally presented. Processing performed by each of the tablet 103 and the search system 104 in order to present difference information to the user is the same as that of the third embodiment except for the following points.

In step S403, the prompt creation unit 303 creates a prompt for inquiring about differences regarding described contents between respective source locations identified by the source location information received in step S402, requesting an output for each piece of difference information of a prescribed number of source locations, and specifying that the number of characters of the difference information of the source locations be equal to or less than a prescribed number of characters. This "prescribed number of characters" may be a value set in advance, or may be set/changed by the user operating the input device 203.

In step S452, the search unit 310 receives the prompt transmitted from the tablet 103 via the communication interface 255. Then, the search unit 310 generates difference information in the same manner as in the third embodiment, but performs processing for fitting the number of characters of the difference information within the number of characters specified in the prompt. For example, the search unit 310 generates "difference information in which the number of characters from the beginning is the number of characters specified in the prompt" by deleting characters such that the number of characters from the beginning in the difference information becomes the number of characters specified in the prompt. Then, every time the search unit 310 generates difference information for a prescribed number of source locations, the search unit 310 transmits the difference information generated for the prescribed number of source locations to the tablet 103 via the communication interface 255.

In step S404, the difference information acquisition unit 304 receives the difference information transmitted from the search system 104 via the communication interface 207. Here, the presentation content determination unit 305 configures a presentation screen in which display areas, where a character string equal to or greater than the number of characters specified in the prompt can be arranged, are arranged at intervals of a prescribed distance for the number of pieces of difference information (the number of paragraph IDs), and causes it to be displayed on the display screen in the presentation device 204.

Then, in step S405, the presentation content determination unit 305 determines the respective differences indicated by the difference information received in step S404 as contents to be presented to the user (presentation contents), and causes the differences to be displayed in the corresponding display areas.

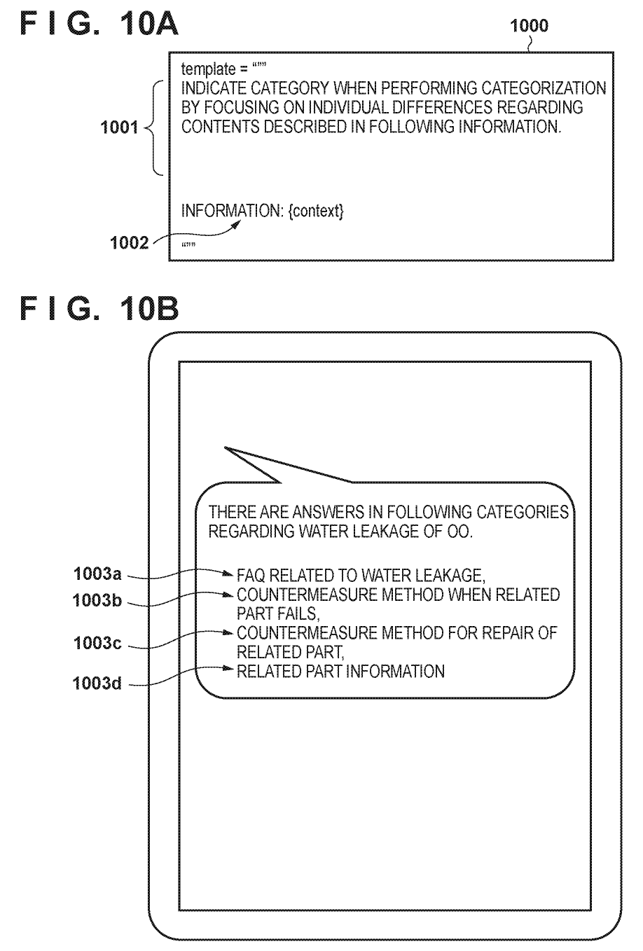

Configuration examples of the presentation screen are shown in FIG. 9. FIG. 9 shows a display example before difference information is additionally presented (left side), and a display example after difference information is additionally presented (right side). Difference information of a first source location is displayed in a display area 901. A display area 902 is an area where difference information of a second and subsequent source locations is displayed. An interval of a prescribed distance is provided between the display areas. The presentation screen after the difference information is displayed in the display area 902 is shown in FIG. 9. As shown in FIG. 9, the display area of the difference information has no change from FIG. 9. Note that the space between the display areas may be blank, or if difference information to be displayed in the display area is being generated, a message indicating "generating" may be displayed. In this way, according to the present modification, the user can easily select a desired search result without confusing information regarding a plurality of different source locations.

### Fourth Embodiment

In the first to third embodiments, differences in described contents of source locations are acquired and presented to the user. In contrast, in the present embodiment, a case will be described where categories of described contents of source locations are presented.

The question acquisition unit 301 acquires a question input according to a user operation. Then, the acquisition unit 302 transmits the question acquired by the question acquisition unit 301 to the search system 104 via the communication interface 207.

The search unit 310 receives the question transmitted from the tablet 103 via the communication interface 255. Then, the search unit 310 generates source location information in the same manner as in the first embodiment, and transmits the generated source location information to the tablet 103 via the communication interface 255.

The acquisition unit 302 receives (acquires) the source location information transmitted from the search system 104 via the communication interface 207. The prompt creation unit 303 creates a prompt for inquiring about a category of described contents of each source location identified by the source location information received from the search system 104.

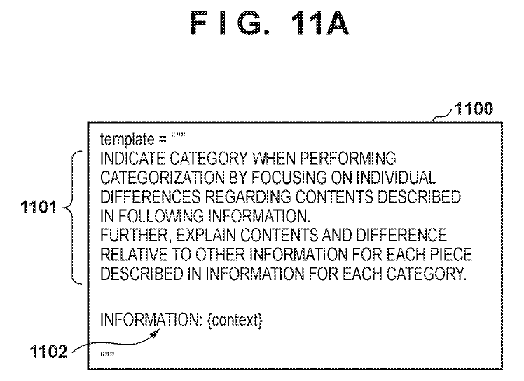

For example, the prompt creation unit 303 creates a prompt by inserting the source location information acquired in step S402 into a prompt template that is a predetermined character string. An example of the prompt template is shown in FIG. 10A. In a prompt template 1000, a description 1001 is a fixed sentence for inquiring about a category of described contents of source locations, but it may be editable as appropriate. A description 1002 is, similar to the above-mentioned description 502, a sentence for specifying a group of source locations. The prompt creation unit 303 inserts the source location information received from the search system 104 as a list of character strings into a "context" part in the description 1002. Then, the prompt creation unit 303 transmits the created prompt to the search system 104 via the communication interface 207.

The search unit 310 receives the prompt transmitted from the tablet 103 via the communication interface 255. Then, the search unit 310 replaces the source location information in the received prompt with a source location corresponding to the source location information (text of a paragraph identified by a paragraph ID and a document ID indicated by the source location information), and by inputting the prompt after the replacement into the large language model 307 and processing the large language model 307, generates a category of described contents of each source location. The large language model 307 in the present embodiment is similar to the large language model 307 of the above-described embodiments except that inputs and outputs are different, and GPT-4 (registered trademark), which is a general-purpose model, is used, and it is a model in which grammar, meanings of words, and the like are pre-trained in an unsupervised manner using a large amount of text data. Then, the search unit 310 transmits the generated category to the tablet 103 via the communication interface 255.

The difference information acquisition unit 304 receives the category transmitted from the search system 104 via the communication interface 207. Then, the presentation content determination unit 305 determines the category of each source location received from the search system 104 as presentation contents, and causes the presentation contents to be presented to the user via the presentation device 204.

For example, the presentation content determination unit 305 may cause a screen including categories 1003a, 1003b, 1003c, and 1003d of the described contents of the respective source locations to be displayed on a display screen of the presentation device 204, as shown in FIG. 10B. Note that the method of presenting the presentation contents is not limited to display, and for example, the presentation contents may be presented to the user by voice.

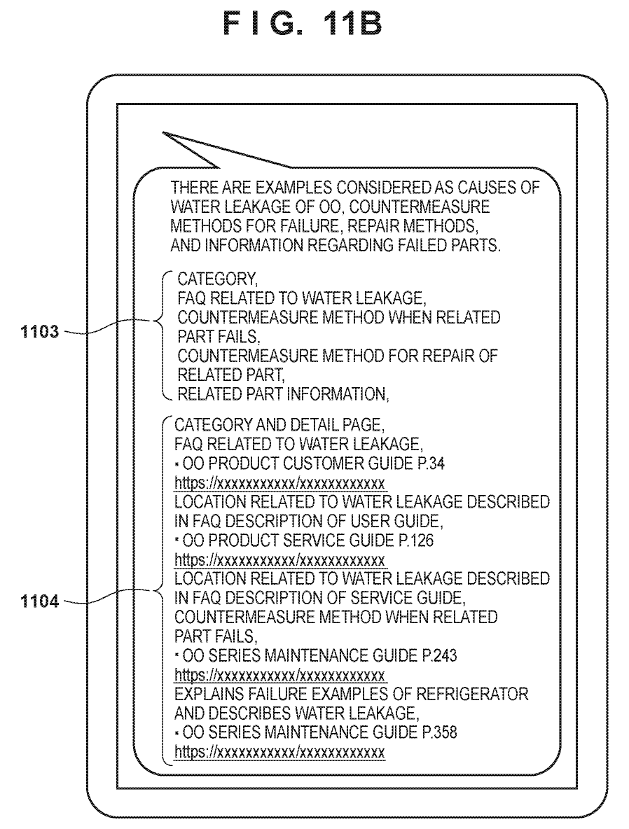

Note that, in the present embodiment, a case where the categories of source locations are presented to the user has been described, but difference information and the categories of the source locations may be presented to the user. In that case, the prompt creation unit 303 creates a prompt with use of a prompt template illustrated in FIG. 11A.

In a prompt template 1100, a description 1101 is a fixed sentence for inquiring about differences in described contents between source locations and categories of the source locations, but it may be editable as appropriate. A description 1102 is a sentence for specifying a group of source locations. The prompt creation unit 303 inserts the source location information received in step S402 into a "context" part in the description 1102 in the format of a list of character strings.

Note that a configuration example of a presentation screen that the presentation content determination unit 305 causes the presentation device 204 to display in a case where source locations are acquired as described above in addition to the difference information and the categories of the source locations is shown in FIG. 11B. A description 1103 indicates a categories of source locations, and a description 1104 indicates the source locations and difference information of the source locations.

Further, if the number of paragraph IDs indicated by the source location information (the number of source locations) is equal to or greater than a threshold, the prompt creation unit 303 creates a prompt for inquiring about a category of described contents of each source location identified by the source location information received from the search system 104.

On the other hand, if the number of paragraph IDs indicated by the source location information (the number of source locations) is less than the threshold, the prompt creation unit 303 creates a prompt for inquiring about differences regarding described contents between the respective source locations identified by the source location information received in step S402. In this way, according to the present embodiment, the user can select a desired search result faster.

### Fifth Embodiment

The usage scene of the system used in the description of the above embodiments and modifications is an example of troubleshooting, and the above system can be applied to other troubleshooting scenes as well. Further, the usage scene of the above system is not limited to troubleshooting.

Further, the tablet 103 and the search system 104 may exist at a location different from the refrigerator 101, for example, on a maintenance company side. In other words, regarding the arrangement of the tablet 103 and the search system 104, various arrangements are conceivable according to the application scene of the system and the like.

Further, in the above embodiments and modifications, a case where the tablet 103 and the search system 104 are separate apparatuses has been described, but this is not a limitation, and for example, one information processing apparatus in which the tablet 103 and the search system 104 are integrated may be configured. In this case, this information processing apparatus executes or controls various types of processing described as processing performed by each of the tablet 103 and the search system 104 (excluding communication processing between apparatuses).

Further, in the above embodiments and modifications, a case has been described where the tablet 103 has the question acquisition unit 301, the acquisition unit 302, the prompt creation unit 303, the difference information acquisition unit 304, and the presentation content determination unit 305, and the search system 104 has the database 306, the large language model 307, and the search unit 310. However, it is not limited to such a case. For example, the tablet 103 may have the search unit 310. Further, the tablet 103 may have the database 306 and the large language model 307. Further, one or more of the functional units shown in FIG. 3 (excluding the presentation device 204) may be implemented by hardware.

Numerical values, processing timings, processing orders, subjects of processing, configurations/acquisition methods/transmission destinations/transmission sources/storage locations of data (information), and the like used in the above embodiments are given as examples for concrete description, and are not intended to be limited to such examples.

Further, a part or all of the embodiments described above may be used in combination as appropriate. Further, a part or all of the embodiments described above may be used selectively.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-060706, filed April 1, 2025, which is hereby incorporated by reference herein in its entirety.

What is claimed is:

1. An information processing apparatus comprising:
an identification unit configured to identify a location in a document including information related to an answer to a question from a user as a source location based on the question;
an acquisition unit configured to acquire a generation result generated by a large language model that has received a prompt instruction for acquiring difference information indicating differences in a plurality of source locations identified by the identification unit, or respective categories of the plurality of source locations identified by the identification unit; and
an output unit configured to output the difference information or the categories based on the generation result.

2. The information processing apparatus according to claim 1, wherein the identification unit performs a search for the source location with use of a plurality of search methods.

3. The information processing apparatus according to claim 1, wherein the identification unit identifies the source location from one or more documents.

4. The information processing apparatus according to claim 3, wherein the acquisition unit acquires the difference information by inputting the prompt instruction to the large language model that outputs a difference for each source location and performing processing of the large language model.

5. The information processing apparatus according to claim 1, wherein in the prompt instruction, the number of source locations for which differences are to be output is specified.

6. The information processing apparatus according to claim 1, wherein in the prompt instruction, a length of the difference information is specified.

7. The information processing apparatus according to claim 1, wherein the output unit outputs the difference information and the source location or an overview of the source location.

8. The information processing apparatus according to claim 1, wherein the output unit outputs a similarity between the question and the source location and the difference information.

9. The information processing apparatus according to claim 1, wherein the output unit outputs, among the difference information acquired by the acquisition unit, difference information of a source location for which a similarity with the question is equal to or greater than a threshold.

10. The information processing apparatus according to claim 1, wherein the output unit outputs the difference information and the source location.

11. The information processing apparatus according to claim 1, wherein the output unit outputs the difference information every time the acquisition unit acquires difference information for a prescribed number of source locations.

12. The information processing apparatus according to claim 1, wherein the acquisition unit acquires the category that is a generation result generated by the large language model that has received a prompt instruction for inquiring about the category if the number of source locations is equal to or greater than a threshold, and acquires the difference information that is a generation result generated by the large language model that has received a prompt instruction for inquiring about the difference information if the number of source locations is less than the threshold.

13. The information processing apparatus according to claim 1, wherein the source location is in a unit of any of a document, a paragraph in a document, a section in a document, a chapter in a document, a page in a document, and a character in a document.

14. An information processing method performed by an information processing apparatus, comprising:
identifying a location in a document including information related to an answer to a question from a user as a source location based on the question;
acquiring a generation result generated by a large language model that has received a prompt instruction for acquiring difference information indicating differences in a plurality of identified source locations, or respective categories of the plurality of identified source locations; and
outputting the difference information or the categories based on the generation result.

15. A non-transitory computer-readable storage medium storing a computer program for causing a computer to function as:
an identification unit configured to identify a location in a document including information related to an answer to a question from a user as a source location based on the question;
an acquisition unit configured to acquire a generation result generated by a large language model that has received a prompt instruction for acquiring difference information indicating differences in a plurality of source locations identified by the identification unit, or respective categories of the plurality of source locations identified by the identification unit; and
an output unit configured to output the difference information or the categories based on the generation result.
